(19) United States
(12) Patent Application Publication
(10) Pub. No.: US 2013/0102252 A1
(43) Pub. Date: Apr. 25, 2013

(54) METHOD FOR COMMUNICATING AND DISTANCE BOUNDING SYSTEM

(71) Applicants: Kasper Bonne Rasmussen, Zurich (CH); Srdjan Capkun, Zurich (CH)

(72) Inventors: Kasper Bonne Rasmussen, Zurich (CH); Srdjan Capkun, Zurich (CH)

(73) Assignee: ETH ZURICH, Zurich (CH)

(21) Appl. No.: 13/641,225

(22) PCT Filed: Apr. 20, 2011
(86) PCT No.: PCT/EP2011/056387

§ 371 Date: Jan. 4, 2013

(30) Foreign Application Priority Data
Apr. 21, 2010 (EP) 10 004 210.0

(51) Int. Cl. H04W 12/06; H04W 12/04

(52) U.S. Cl. CPC H04W 12/06; H04W 12/04
USPC 455/41.2

(57) ABSTRACT

The method for communicating between a first device and a second device includes the steps of: the first and second device communicating by exchanging messages that are based on signals that are transmitted through a plurality of communication channels; the first device sending a challenge message to the second device over one communication channel; the second device sending, upon reception of the challenge message, a response message to the first device through at least two communication channels that have essentially identical signal propagation velocities; the first device measuring the time elapsed between the sending of the challenge message to the reception of the response message; and the first device computing its distance to the second device based on this time, knowledge about travelling speed of the challenge and the response message and the processing delay that the second device adds to generate and send the response message.

### TECHNICAL FIELD

The invention relates to the field of wireless communication, in particular to the field of wireless communication networks, more particularly to authentication and access control for devices controlled by wireless communication. It relates to methods and apparatuses according to the opening clauses of the claims.

### BACKGROUND OF THE INVENTION

Distance bounding, as a concept, was first proposed by Brands and Chaum in [3] who introduced techniques enabling a verifier to determine an upperbound on the physical distance to a prover (as summarized in Section 2). In addition, they considered the case where the verifier also authenticates the prover in addition to establishing the distance bound.

Several optimizations and studies of distance bounding were subsequently proposed for wireless networks, including [28, 30, 5] and for sensor networks [18, 5, 27]. Distance bounding protocols have also been proposed in other contexts, e.g., for RFIDs [13, 10, 19] and ultra wide band (UWB) devices [17, 12].

In [23] the authors studied information leakage in distance bounding protocols. A mutual distance bounding protocol using interleaved challenges and responses was proposed in [31] and in [28] and [5] the authors investigated the use of distance bounding protocols for location verification and secure localization. Sastry, Shankar and Wagner [25] proposed the so-called “in-region verification” appropriate for certain applications, such as location-based access control. Collusion attacks on distance bounding location verification protocols where considered in [7, 6]. Ultrasonic distance bounding was used for access control [25] and for key establishment [32]. In [22] ultrasonic distance bounding was further used for proximity based access control to implementable medical devices. Other attacks have been proposed against distance bounding protocols in general. The so-called “late-commit” attacks where proposed in [14], where the attacker exploits the modulation scheme in order to manipulate the distance. Bit guessing attacks [8] that accomplish the same thing where also proposed. These attacks were further studied in practical implementations in [11].

It is desirable to provide an alternative, in particular an improved way of realizing distance bounding.

### SUMMARY OF THE INVENTION

Until now, most of the work done in this field of distance bounding has been theoretical. To the inventors' knowledge, the work presented in this patent application is the first to propose a realizable distance bounding protocol using radio communication, with a processing time at the prover that is low enough to provide a useful distance granularity.

An alternative and, in particular an improved way of realizing distance bounding shall be provided, more particularly, a method for communicating between a first device and a second device shall be provided. In addition, a corresponding distance bounding system, a corresponding first device and also a corresponding second device shall be provided.

The method for communicating between a first device and a second device comprises the steps of
the first and second device communicating by exchanging messages that are based on signals that are transmitted through a plurality of communication channels;
the first device sending a challenge message to the second device over one communication channel;
the second device sending upon reception of the challenge message a response message to the first device through at least two communication channels that have essentially identical signal propagation velocities;
the first device measuring the time elapsed between the sending of the challenge message to the reception of the response message;
the first device computing its distance to the second device based on this time, knowledge about travelling speed of the challenge and the response message and the processing delay that the second device adds to generate and send the response message;
   wherein the second device
encodes its response message essentially by choosing a subset of the at least two communication channels;
generates said response message purely through an analogue signal processing means.

Said second device can be, e.g., a reader for reading data from the first device. In particular, said second device can be destined for controlling the first device.

The distance to the second device computed by the first device is thus based on said measured time which elapsed between the sending of the challenge message and the reception of the response message, on knowledge about the travelling speed of the challenge and the response messages, and on knowledge about the processing delay the second device adds because it has to generate and send the response message.

In one embodiment, the method comprises the step of
the first and second device by exchanging the messages, establish a shared secret key.

In one embodiment which may be combined with the before-addressed embodiment, the method comprises the steps of
defining a fixed nonce length for the first device and a fixed nonce length for the second device;
given a shared secret key, the first and second device each picking a random nonce at the defined lengths;
the first device encoding its chosen nonce into the challenge message;
calculating a constant time period as a fraction of the temporal length of the challenge message and thus a number of such constant time periods that fit into the temporal length of the challenge message;
the second device encoding its chosen nonce into the resulting number of calculated constant time periods, by choosing a subset of communication channels of the at least two communication channels for each of the defined constant time periods, to essentially reflect the portion of the challenge message that the second device receives during that constant time period, until the entire challenge message is piecewise reflected, this way, and the entire chosen nonce of the second device is encoded through this continuous choice of communication channels;
the first device decoding the chosen nonce of the second device by listening on the plurality of communication channels and knowledge of the constant time period and knowledge of the way the second device encodes its nonce into the choice of the subset of communication channels.

In one embodiment referring to the before-addressed embodiment, the method comprises the steps of
the second device signing the nonce of the first device and the nonce of the second device with a shared secret key and thus establishing an additional message;
the second device sending that additional message to the first device;
the first device verifying the additional message by knowledge of his chosen nonce, the nonce chosen by the second device previously decoded by listening on the plurality of communication channels and by knowledge of the shared secret key.

In one embodiment referring to one of the two before-addressed embodiments the credential information is a preshared key known to the first and the second device, or the credential information is a cryptographic certificate, and preferably the credential information is stored on a storage device that is separable from the second device.

In one embodiment which may be combined with one or more of the before-addressed embodiments, all of the communication channels are based on RF communication.

In one embodiment which may be combined with one or more of the before-addressed embodiments, the step of controlling access of the second device to the first device, in addition to the distance, takes into account credential information.

In one embodiment which may be combined with one or more of the before-addressed embodiments, the first device comprises two or more levels of access, and the method comprises the further step of
the first device controlling access to the different levels of access depending on the value of the computed distance.

The distance bounding system comprises a first device and a second device, said first device being configured to communicate with said second device, and said second device being configured to communicate with said first device, said first device comprising
a first transceiver for sending and receiving messages through a first communication channel;
a receiver for listening to a plurality of communications channels;
the first device being configured to
   exchange messages through the first communication channel and/or through the plurality of communication channels;
   to compute the distance to the second device based on communication signal delays caused by the difference in signal propagation velocities; and
   depending on the computed distance, to accept data from the second device and optionally also to control access to the device;
      said second device comprising
a second transceiver for sending and receiving messages through said first communication channel;
at least one other transceivers for sending messages through a second or further communication channels;
an analogue processing means, capable of reflecting received messages from the first transceiver and selecting the communication channel through which the received message is reflected;
   in particular wherein said second or further communication channels are comprised in said plurality of communication channels.

In one embodiment of the distance bounding system referring to the before-addressed embodiment, the analogue processing means and/or one of the transceivers of the second device comprise
an electronic oscillator, oscillating with a frequency Δf;
a high pass filter with a cut off frequency below f_{c}+Δf and above f_{c}−Δf, with f_{c} being the center frequency of the first communication channel;
a low pass filter with a cut off frequency above f_{c}−Δf and below f_{c}+Δf;
an analogue selector with a first input signal having a center frequency of f_{c}+Δf, a second input signal having a center frequency of f_{c}−Δf and a third, essentially binary input, selecting one of the two first input signals as its output signal.

As indicated before, also the first device and the second device can be considered to be separately comprised in the invention, namely in the following way:

The first device is configured to communicate with a further device and comprises
a transceiver for sending and receiving messages through a first communication channel;
a receiver for listening to a plurality of communications channels;
the device being configured to
   exchange messages through the first communication channel and/or through the second plurality of communication channels;
   to compute the distance to the further device based on communication signal delays caused by the difference in signal propagation velocities; and
   depending on the computed distance, to accept data from the further device and optionally also to control access to the device.

The second device is configured to communicate with a further device and comprises
a first transceiver for sending and receiving messages through a first communication channel;
at least one other transceivers for sending messages through a second or further communication channels;
an analogue processing means, capable of reflecting received messages from the first transceiver and selecting the communication channel through which the received message is reflected.

In one embodiment of the second device, the analogue processing means and/or one of the transceivers comprise
an electronic oscillator, oscillating with a frequency Δf;
a high pass filter with a cut off frequency below f_{c}+Δf and above f_{c}−Δf, with f_{c} being the center frequency of the first communication channel;
a low pass filter with a cut off frequency above f_{c}−Δf and below f_{c}+Δf;
an analogue selector with a first input signal having a center frequency of f_{c}+Δf, a second input signal having a center frequency of f_{c}−Δf and a third, essentially binary input, selecting one of the two first input signals as its output signal.

The advantages of the methods basically correspond to the advantages of corresponding apparatuses (systems, devices) and vice versa.

Further embodiments and advantages emerge from the dependent claims and the figures.

### BRIEF DESCRIPTION OF THE DRAWINGS

Below, the invention is described in more detail by means of examples and the included drawings. The figures show:

FIG. 1 an illustration of a distance measurement phase;

FIG. 2 a schematic illustration of a prover;

FIG. 3 an illustration of a verifier measuring the time between sending a challenge signal and receiving a reply signal;

FIG. 4 an illustration of an RF distance bounding protocol;

FIG. 5 an illustration of a man in the middle attack;

FIG. 6 a picture showing a prototype implementation of a prover;

FIG. 7 (7a, 7b) an illustration of the delay of a prover's distance bounding radio extension using cable-bound (a) and wireless (b) transmission, respectively;

FIG. 8 a diagram showing processing time at a prover;

FIG. 9 an illustration of an RF distance bounding protocol;

FIG. 10 an illustration of a man in the middle attack. The described embodiments are meant as examples and shall not confine the invention.

### DETAILED DESCRIPTION OF THE INVENTION

Generally, the present invention relates to realization of RF distance bounding.

The following presents a short summary of the here-presented work:

One of the main obstacles for the wider deployment of radio (RF) distance bounding is the lack of platforms that implement these protocols. We address this problem and we build a prototype system that demonstrates that radio distance bounding protocols can be implemented to match the strict processing that these protocols require. Our system implements a prover that is able to receive, process and transmit signals in less than 1 ns. The security guarantee that a distance bounding protocol built on top of this system therefore provides is that a malicious prover can, at most, pretend to be about 15 cm closer to the verifier than it really is. To enable such fast processing at the prover, we use specially implemented concatenation as the prover's processing function and show how it can be integrated into a distance bounding protocol. Finally, we show that functions such as XOR and the comparison function, that were used in a number of proposed distance bounding protocols, are not best suited for the implementation of radio distance bounding.

Please note that mentioning “we” and “our” refers to the inventors.

The rest of the chapter “Detailed Description of the Invention” of the present patent application is organized as follows. After Section 1 as an introduction, in Section 2 we describe the basic operation of distance bounding protocols. In Section 3, we discuss prover's processing functions and their appropriateness for the implementation of radio distance bounding. In Section 4 we describe the design of our distance bounding protocol (and in Section 4A the design of an alternative distance bounding protocol of ours) and in Section 5 we analyze its security (and in Section 5A we analyze the security of said alternative distance bounding protocol of ours). In Section 6 we present our implementation and our measurement results. We conclude in Section 7.

### Section 1) Introduction

Distance bounding denotes a class of protocols in which one entity (the verifier) measures an upperbound on its distance to another (untrusted) entity (the prover). In recent years, distance bounding protocols have been extensively studied: a number of protocols were proposed [3, 13, 10, 19, 30, 15, 25, 17, 12, 29] and analyzed [8, 26, 11, 23]. The use of distance bounding was suggested for secure localization [28], location verification [25], wormhole detection [16,27], key establishment [22,32] and access control[22].

Regardless of the type of distance bounding protocol, the distance bound is obtained from a rapid exchange of messages between the verifier and the prover. The verifier sends a challenge to the prover, to which the prover replies after some processing time. The verifier measures the round-trip time between sending its challenge and receiving the reply from the prover, subtracts the prover's processing time and, based on the remaining time, computes the distance bound between the devices. The verifier's challenges are unpredictable to the prover and the prover's replies are computed as a function of these challenges. In most distance bounding protocols, a prover XORs the received challenge with a locally stored value [3] or uses the received challenge to determine which of the locally stored values it will return [13,29]. Thus, the prover cannot reply to the verifier sooner than it receives the challenge, it can only delay its reply. The prover, therefore, cannot pretend to be closer to the verifier than it really is; only further away.

One of the main assumptions on which the security of distance bounding protocols relies is that the time that the prover spends in processing the verifier's challenge is negligible compared to the propagation time of the signal between the prover and the verifier. If the verifier overestimates the prover's processing time (i.e., the prover is able to process signals in a shorter time than expected), the prover will be able to pretend to be closer to the verifier. If the verifier underestimates this time (i.e., the prover needs more time to process the signals than expected), the computed distance bounds will be too large to be useful.

The challenge in implementing distance bounding protocols is therefore to implement a prover that is able to receive, process and transmit signals in negligible time. This requirement can be easily met with ultrasonic distance bounding implementations where the prover's processing needs to be in the order of μs. However, because ultrasonic distance bounding is vulnerable to RF wormhole attacks [16, 27], its application is limited to few specific applications (e.g., [22]). For most applications, radio distance bounding is the main viable way of verifying proximity to or a location of a device. In this case, the prover's processing time needs to be about 1 ns which would, in the worse case, allow a malicious prover to pretend to be closer to the verifier by approx. 15 cm (assuming that the malicious prover is able to process signals instantaneously). Currently available platforms do not support such fast processing. This strict processing requirement has been, so far, one of the main obstacles for the wider deployment of RF distance bounding protocols and related solutions.

In the here-presented work, we address this problem. We make the following contributions. We build a prototype system that demonstrates that radio (RF) distance bounding protocols can be implemented to match the prover's strict processing requirements (i.e., that the prover's processing time is below 1 ns). We use concatenation as the prover's processing function and implement it using a scheme that we call Challenge Reflection with Channel Selection (CRCS). Our implementation eliminates the need for signal conversion and demodulation since it does not require that the received challenges are interpreted by the prover before the prover responds to them. Our prover is therefore able to receive, process and transmit signals in less than 1 ns. We design a distance bounding protocol that uses concatenation, implemented with CRCS, as the prover's processing function and we analyze its security; we base this protocol on Brands and Chaum's original distance bounding protocol[3].

We further show that processing functions such as XOR and the comparison function, that were used in a number of proposed distance bounding protocols, are not best suited for the implementation of radio distance bounding. The main reason is that, although XOR and comparison can be executed fast, these functions require that the radio signal that carries the verifier's challenge is demodulated, which, with today's state-of-the-art hardware, results in long processing times (typically 50 ns). The design and implementation of distance bounding protocol based on concatenation shows that the use of functions which require (in their radio implementation) that the prover demodulates (interprets) the verifier's challenge before responding to it is not necessary for the implementation of radio distance bounding.

To our knowledge, the here-presented work is the first to propose a realizable distance bounding protocol using radio communication, with a processing time at the prover that is low enough to provide a useful distance granularity.

### Section 2) Background on Distance Bounding Protocols

Distance bounding protocols were first introduced by Brands and Chaum [3] for the prevention of mafia-fraud attacks on Automatic Teller Machines (ATMs). The purpose of Brands and Chaum's distance bounding protocol was to enable the user's smart-card (verifier) to check its proximity to the legitimate ATM machine (prover).

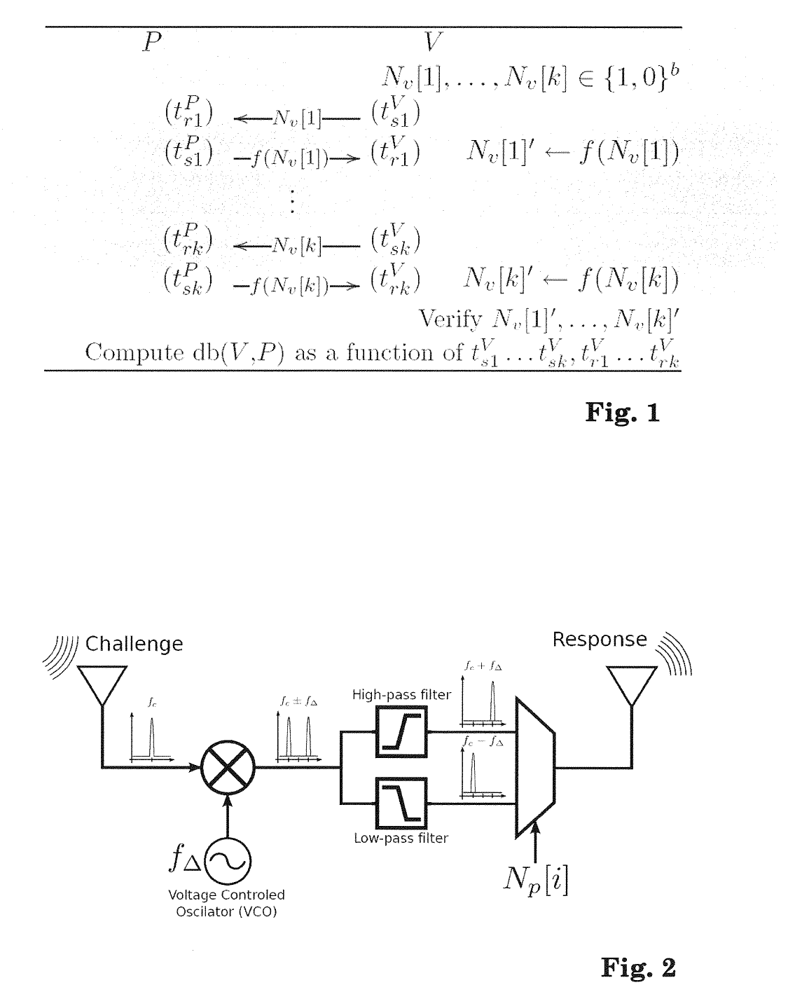

The core of all distance bounding protocols is the distance measurement phase (shown in FIG. 1). FIG. 1 shows an illustration of a distance measurement phase. The distance measurement phase of distance bounding protocols consists of a rapid exchange of messages where the verifier measures the round-trip time between sending its challenges and receiving the replies from the prover. In the distance measurement phase the verifier measures the round-trip time between sending its challenge and receiving the reply from the prover. More precisely, the verifier challenges the prover with a b-bit freshly generated nonce Nᵥ (typically b=1). Upon reception of the challenge, the prover computes a response f^{P}(Nᵥ), and sends it to the verifier. This process is repeated k times. After the challenge-response exchange the verifier verifies the authenticity of the replies (in this step distance bounding protocols differ) and measures the time t^{V}ₛ−t^{V}ᵣ between the challenge and the response. Based on the measured times, the verifier estimates the upper-bound on the distance to the prover. The time t^{P}ₛ−t^{P}ᵣ between the reception of the challenge and the transmission of the response at the prover is either negligible compared to the propagation time t^{P}ᵣ−t^{V}ₛ or is lower bounded by the prover's processing and communication capabilities δ, i.e., t^{P}ₛ−t^{P}ᵣ≧δ. After the execution of a distance bounding protocol the verifier knows that the prover is within a certain distance, namely:

$$dist = \frac{{t}_{s}^{V} - {t}_{r}^{V} - δ}{2} \cdot c$$

where δ is the processing time of the prover (ideally 0) and c is the propagation of the radio signal.

Although the designs of distance bounding protocols differ [3, 13, 10, 19, 30, 15, 25, 17, 12, 29], given their common distance measurement phase, their security relies on the same underlying ideas. We briefly summarize them here. Distance fraud attacks [3], in which the prover tries to pretend to be closer to the verifier, are prevented by the following: (i) the prover cannot generate the reply before it receives the challenge and (ii) the duration of time the verifier accounts that the prover will process the reply is not longer than the prover's actual processing time. The Mafia-fraud (or man-in-the-middle—MITM) attack [9], by which an attacker convinces the verifier that the prover is closer than it really is, is prevented since the attacker cannot predict exchanged challenges/replies and since it cannot speed-up the propagation of messages (the messages propagate at the speed of light over a radio channel). Given this, the attacker cannot shorten the distance measured between the verifier and the prover. Distance bounding protocols therefore provide the verifier with an upper-bound on its physical distance to the prover.

### Section 3) Functions Appropriate for Distance Bounding Realization

As discussed in Section 2, one of the main assumptions on which the security of distance bounding protocols relies is that the time that the prover is allowed to spend in processing the verifier's challenge is negligible compared to the propagation time t^{P}ᵣ−t^{V}ₛ of the signal between the prover and the verifier. In most applications, the prover's processing time would therefore need to be around 1 ns. This would, in the worse case, allow a malicious prover to pretend to be closer to the verifier by approx. 15 cm (assuming that the malicious prover is able to process signals instantaneously). Such short processing time currently cannot be achieved with existing off-the-shelf platforms.

The main challenge is therefore to design distance bounding protocols which use prover processing functions f(Nᵥ) that can be implemented such that they can be executed in ≦1 ns. Before presenting a function that is well suited for this purpose, we first discuss functions that were used in distance bounding protocols that are proposed in the open literature.

The first (obvious) candidate processing functions are various encryption functions, hash functions, message authentication codes and digital signatures; the use of digital signatures for this purpose was proposed by Beth and Desmedt in [1]. The use of such functions would largely simplify the design of distance bounding protocols; it would be sufficient to use well studied challenge-response authentication protocols [2] where the verifier would measure the round-trip time between the issued challenge and the received response. However, the processing time for these functions even with the fastest available implementations by far exceeds the required processing time.

In [3] Brands and Chaum proposed a distance bounding protocol that uses XOR as a processing function. In this protocol the prover XORs the verifiers challenge with the value that the prover wants to transmit back and sends the result back to the verifier. The main reasoning behind this choice was that XOR is a fast operation and that it should be feasible to execute it within the required processing time. Hancke and Kuhn [13] propose a distance bounding protocol where the prover, based on the verifier's challenge chooses from which of the two local registers it should send a value back. Again, one of the main reasons for choosing this function was that such a function (comparison and access) can be executed fast.

Although XOR and comparison can be executed fast, these functions require that the radio signal that carries the verifier's challenge is converted from an analog to a digital signal (ADC) and demodulated. Only when it is demodulated, the challenge can be used by the prover in an XOR function or for the selection of the register. Equally, in order to communicate the reply back to the verifier, the prover needs to modulate the signal and convert it from the digital to the analog signal (DAC). These steps, signal detection, ADC/DAC conversion and signal modulation/demodulation, increase the provers processing delay by approx. 170 ns [24], not including possible RX/TX switching costs. (The inventors are not aware of the radio design that can perform these operations faster.) The implementations of an XOR or of a comparison function that require the signals to be digitalized and demodulated therefore require such processing which, using today's state-of-the-art hardware, is not sufficiently fast to meet the security requirements of distance bounding protocols. Even if some processing steps can be sped-up or removed, the prover will still need a way of (reliably) detecting if it received a challenge that corresponds to a bit “0” or a bit “1”, which requires some processing and thus reduces the security guarantees of the protocol. Namely, every nanosecond of additional processing in the implementation of the prover means that a malicious prover with a faster implementation shorten the measured distance even further.

In what follows, we show that the choice of a concatenation function as the prover's processing function, when implemented using a scheme that we call Challenge Reflection with Channel Selection (CRCS) eliminates the need for signal conversion and demodulation since it does not require that the received challenges are interpreted by the prover before the prover responds to them. The prover, implemented using CRCS is therefore able to receive, process and transmit signals in less than 1 ns.

Section 3.1) Prover: Concatenation Implemented using Challenge Reflection with Channel Selection

In this section we describe our implementation of concatenation as the prover's processing function.

Bit concatenation CAT: Nₚ[i]×Nᵥ[i]→r[i]=Nᵥ[i]∥Nₚ[i] takes as input the verifier's challenge bit Nᵥ[i] and the prover's input bit Nₚ[i] and returns a two-bit reply r[i]=Nᵥ[i]∥Nₚ[i]. CAT is therefore given by the following table.

Nᵥ[i]

| | Nₚ[i] | 0 | 1 |
|---|---|---|---|
| CAT: | 0 | 00 | 10 |
| | 1 | 01 | 11 |

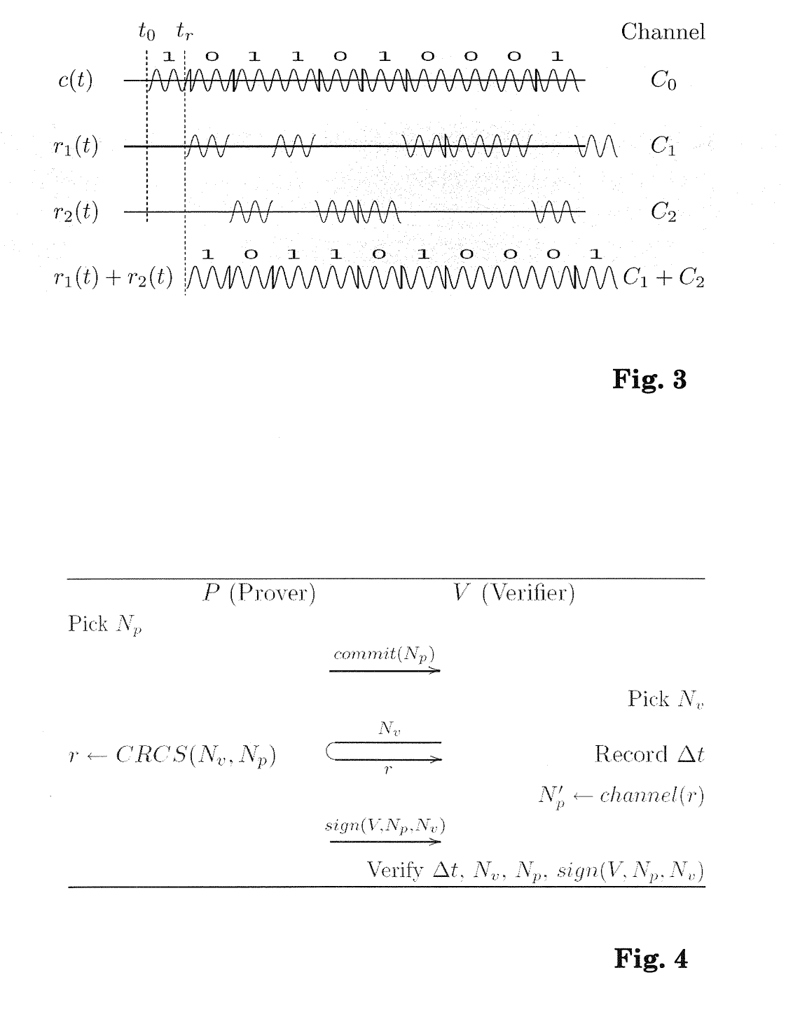

In order for concatenation to be useful for distance bounding, we implement it by Challenge Reflection with Channel Selection. Our implementation uses three (non-overlapping) communication channels. The verifier sends its challenge bits to the prover using one communication channel C₀, whereas the prover replies using two communication channels C₁, C₂ (FIG. 3).

While it is receiving the verifier's challenge bit (i.e., the signal that encodes it), the prover is responding with the same signal (bit), but it is sending it on either channel C₁ or channel C₂, depending on its current input bit Nₚ[i]. For every challenge bit that it received from the verifier, the prover therefore transmits two bits of the reply back to the verifier, encoded in the form of the signal (it reflect back the same signal that it received) and of the response channel (it chose the channel on which to reply). The response r=10 is then interpreted as: the challenge bit 1 is reflected on channel C₁, where the channel C₁ denotes bit 0, and channel C₂ denotes bit 1). The prover therefore implements challenge reflection with channel selection. Note that, although the prover replies with two bits for each challenge bit, the duration of transmission of those two bits is the same as for a single bit of the verifier's challenge, since the second bit of the prover's reply is encoded in the form of channel selection. This is illustrated on FIG. 3.

FIG. 3 illustrates that the verifier measures the time between sending a challenge signal c(t) and receiving the reply signal r(t)=r₁(t)+r₂(t). If c(t)=r(t), the distance bound to the prover is then given by (tᵣ−tₒ) c, where c is the speed of light.

The schematic of our prover implementing CRCS is shown on FIG. 2. FIG. 2 is a schematic illustration of the prover (i.e., of the implementation of concatenation as its processing function using CRCS). The figure shows the signal in the frequency domain at various stages of the circuit. The challenge-signal (with center frequency f_{c}) is received by the receiving antenna (on the left) and multiplied by f_{Δ}. This multiplication shifts the signal by ±f_{Δ} to the channels on two sides of the original channel. The bit of the prover's nonce Nₚ[i] determines which of the two channels is used to send the response on the transmitting antenna (on the right).

The figure shows the signal in the frequency domain as it passes through various stages of the prover's circuit. The prover receives the challenge-signal (centered at the frequency f_{c}) on the receiving antenna. The received signal is then multiplied by f_{Δ} which creates two signals on two channels each with central frequencies f_{c}+f_{Δ} and f_{c}−f_{Δ}, respectively. The current bit of the prover's nonce Nₚ[i] determines which of the two channels are used to send the response signal on the transmitting antenna. The verifier's signal is thus reflected back on the channel selected by the prover. Here, the verifier's challenge bit can be encoded in the challenge signal using e.g., Pulse Amplitude Modulation (PAM) or Binary Phase Shift Keying Modulation (both of which are used with Ultra-Wide-Band ranging systems). The prover's response carries two bits, one encoded in the signal that it sends back (the same bit that it received by the verifier), and the other encoded in the channel on which it responds (i.e., Nₚ[i]).

Here, signal multiplication and selection are done using analog components only. Namely, the challenge signal passes through an analog mixer where it is multiplied with a local oscillator signal with a frequency f_{Δ}. This mixer outputs two signals on frequencies f_{c}+f_{Δ} and f_{c}−f_{Δ}, which are separated by a high-pass and a low-pass filter, respectively. Finally, the Nₚ[i] bit (which the prover have committed to), determines which of the two signals will be transmitted back to the verifier.

### Section 3.2 Verifier: Calculation of the Distance Bound

FIG. 3 shows the calculation of the distance bound by the verifier (the signals are shown in the time domain). The verifier notes the exact time tₒ when it starts transmitting the challenge bits Nᵥ[i], . . . Nᵥ[k] encoded in the signal r₁(t), and then listens on the two reply channels C₁ and C₂ (that correspond to the frequencies f_{c}+f_{Δ} and f_{c}−f_{Δ}). When a reply comes back (e.g., on channel C₁) the verifier will mark the exact time tᵣ of the arrival of the signal. The verifier will then wait for the arrival of the entire challenge, noting for every time slot on which channel the reply was sent. After the entire nonce has been received and processed by the radio, the verifier checks that the data bits in the reply are the same as those sent in the challenge, i.e., that c(t)=r₁(t)+r₂(t). If that is the case, the distance bound is then computed as (tᵣ−t₀) c, where c is the speed of light. This bit comparison is important for the security of our distance bounding protocol (as we detail in Section 4); it can be efficiently done using autocorrelation, which can then simultaneously be used to calculate the time difference (e.g., as it is used in GPS [20]).

The following section comprises two parts, the first (Section 4) concerning a first of our distance bounding protocols, and the second (Section 4A) concerning an alternative distance bounding protocol of ours.

### Section 4) Distance Bounding Realization

In this section we present our distance bounding protocol and its realization. The protocol uses concatenation implemented using CRCS as the prover's processing function. The main security properties that we want our protocol to achieve are resilience to distance fraud and Mafia fraud attacks.

Our RF distance bounding protocol is shown in FIG. 4. It is similar to (or even closely resembles) the original protocol of Brands and Chaum [3], except that it does not use rapid bit exchange, but instead uses full duplex communication with signal streams. XOR is replaced with the concatenation function, and additional checks by the prover and the verifier are added to make sure the implementation of concatenation using CRCS does not introduce vulnerabilities.

The prover starts the protocol by picking a fresh nonce Nₚ and by sending to the verifier a commitment to the nonce (e.g., a hash of the nonce). Already now, the prover will activate its distance bounding hardware and set the output channel according to a random bit. From this moment, any signal that the prover receives on channel C₀ will be reflected on the output channel that is set. However, the prover does not yet start switching between output channels.

Upon receiving the commitment, the verifier picks a fresh nonce Nᵥ and prepares to initiate the distance bounding phase in which it will measure the distance bound to the prover. The verifier starts a high precision clock to measure the (roundtrip) time of flight of the signal and begins to transmit his nonce Nᵥ on channel C₀. From this point on, the verifier will also listen on the two reply channels C₁ and C₂ and will keep listening on the two channels until he either receives the expected response from the prover or until he detects an error and aborts the protocol.

As soon as the prover receives (and demodulates) the first bit of Nᵥ on C₀, he starts switching reply channels according to the bits of his nonce Nₚ. Here, we note that while the first few bits are being demodulated, the prover is still reflecting the input (challenge) bits, but he did not start the switching of the channels (i.e., he did not start sending back Nₚ). The demodulation of the bits is not done within the distance bounding hardware (that we call the distance bounding extension), but is done in the prover's regular radio. It is not important how long it takes for the prover's radio to demodulate the first bits, since the prover does not need to begin to switch the output channels within any predefined time (as long as the switching starts within the duration of Nᵥ and allows the transmission of Nₚ). Equally, the first part of Nᵥ could be known and constitute a public, fixed-length preamble upon the detection of which the prover would start switching the channels (i.e., would start sending Nₚ).

When the prover starts sending Nₚ, he will send the bits of Nₚ with a fixed frequency (e.g., every 500 ms) by switching channels depending on the value of the current bit (FIG. 3). In each interval, the prover will therefore reflect back several bits of Nᵥ and a single bit of Nₚ. The bit of Nₚ is encoded in the choice of the reply channel. The prover will, in parallel, also receive the challenge on channel C₀ using his regular radio and will demodulate it.

When the verifier has sent all the bits of his nonce, he waits for the prover to complete the reflection of the signal and then both the prover and verifier disable their distance bounding extensions. The verifier can then use an auto-correlation detector like the ones used in GPS receivers [20] to determine the exact time of flight of the reflected signal. This can also be done during the distance bounding phase, i.e., in parallel to the analog distance bounding circuit.

After the (time-critical) distance bounding phase is complete the prover sends a signed message containing his nonce Nₚ, the identity of the verifier V and the verifier's nonce Nᵥ to the verifier. The verifier must then check five things:
That all the bits of Nₚ reflected by the prover are of the same width (time duration). This is necessary to prevent mafia fraud and is described in more detail in Section 5.3.
The data that was reflected back from the prover must be exactly the same as what was sent. I.e., when the signal r(t)=r₁(t)+r₂(t) is demodulated, the message must contain Nᵥ. This is visualized in FIG. 3.
The value of N′ₚ obtained during the distance bounding phase must match the commitment sent in the first protocol message.
The signature of the final message must be valid and it must correspond to the expected identity of the prover.
The time of flight of the signal Δt must be less than some predefined upper limit tₘₐₓ. The upper limit is application dependent. E.g., it can be the radius of some region of interest, or it can be the (estimated) maximum transmission range of the radio.

The order in which these checks are performed is not important but all checks must pass for the distance bound to be accepted. If all the checks pass, the verifier calculates the distance to the prover as

$$d = \frac{Δ t - {δ}_{p}}{2} \cdot c \qquad ( 1 )$$

Where c is the speed of light and δₚ is the very small processing delay of the prover. In our implementation δₚ<1 ns resulting in a maximum error on about 15 cm.

### Section 4A) Alternative Distance Bounding Realization

In this section we present our alternative distance bounding protocol and its realization. The alternative protocol uses concatenation implemented using CRCS as the prover's processing function. The main security properties that we want this protocol to achieve are resilience to distance fraud and Mafia fraud attacks.

Our alternative distance bounding protocol is shown in FIG. 9. It Is similar to (or even closely resembles) the original protocol of Brands and Chaum [10], except that it does not use rapid bit exchange, but instead uses full duplex communication with signal streams.

XOR is replaced with the concatenation (CRCS) function, and additional checks by the prover and the verifier are added to make sure the implementation of concatenation using CRCS does not introduce vulnerabilities.

The prover starts the alternative protocol by picking a fresh (large) nonce Nₚ. The prover then sends a commitment (e.g., a hash) to the nonce and its identity, to the verifier. Already now, the prover will activate its distance bounding hardware and set the output channel according to the opposite of the first bit of the nonce Nₚ. From this moment, any signal that the prover receives on channel C₀ will be reflected on the output channel that is set. However, the prover does not yet start switching between output channels.

Upon receiving the commitment, the verifier picks a fresh (large) nonce Nᵥ and prepares to initiate the distance bounding phase in which it will measure the distance bound to the prover. The verifier starts a high precision clock to measure the (roundtrip) time of flight of the signal and begins to transmit his nonce Nᵥ on channel C₀. From this point on, the verifier will also listen on the two reply channels C₁ and C₂ and will keep listening on the two channels until he either receives the expected response from the prover or until he detects an error and aborts the alternative protocol.

As soon as the prover receives (and, in parallel demodulates) the first bit of Nᵥ on C₀, he starts switching reply channels according to the bits of his nonce Nₚ. Here, we note that while the first few bits are being demodulated, the prover is still reflecting the input (challenge) bits, but he did not start the switching of the channels (i.e., he did not start sending back Nₚ). The demodulation of the bits is not done within the distance bounding hardware (that we call the distance bounding extension), but is done in the prover's regular radio. It is not important how long it takes for the prover's radio to demodulate the first bits, since the prover does not need to begin to switch the output channels within any predefined time, as long as the prover keeps track of the delay and the switching starts within the duration of Nᵥ, and allows the transmission of Nₚ. The first part of Nᵥ could even be known and constitute a public, fixed-length preamble upon the detection of which the prover would start switching the channels (i.e., would start sending Nₚ).

When the prover starts sending Nₚ, he will send the bits of Nₚ with a fixed frequency (e.g., every 100 ms) by switching channels depending on the value of the current bit (FIG. 3). In each interval, the prover will therefore reflect back several bits of Nᵥ and a single bit of Nₚ. The bit of Nₚ is encoded in the choice of the reply channel. The prover will, in parallel, also receive the challenge on channel C₀ using his regular radio and will demodulate it.

When the verifier has sent all the bits of his nonce, he waits for the prover to complete the reflection of the signal and then both the prover and verifier disable their distance bounding extensions. The verifier can then use an auto-correlation detector like the ones used in GPS receivers [20] to determine the exact time of flight of the reflected signal. This can also be done during the distance bounding phase, i.e., in parallel to the analog distance bounding circuit.

After the (time-critical) distance bounding phase is complete the prover sends a signed message containing the initial commitment cₚ, the delay n, his nonce Nₚ, the identity of the verifier V and the verifier's nonce Nᵥ to the verifier. The verifier must then check six things:
That all the bits of Nₚ reflected by the prover are of the same width (time duration). This is necessary to prevent mafia fraud and is described in more detail in Section 5A.
The data that was reflected back from the prover must be exactly the same as what was sent. I.e., when the signal r(t)=r₁(t)+r₂(t) is demodulated, the message must contain Nv. This is visualized in FIG. 3.
The value of N′ₚ obtained during the distance bounding phase must match the commitment sent in the first protocol message.
The signature of the final message must be valid and it must correspond to the expected identity of the prover.
The delay n reported by the prover (measured, e.g., in either nanoseconds or periods of the carrier signal) must match the delay observed by the verifier. This is also a useful measure for preventing mafia fraud and is described in more detail in Section 5A.
The time of flight of the signal Δt must be less than some predefined upper limit tmax. The upper limit is application dependent. E.g., it can be the radius of some region of interest, or it can be the (estimated) maximum transmission range of the radio.

The order in which these checks are performed is not important but all checks must pass for the distance bound to be accepted. If all the checks pass, the verifier calculates the distance to the prover according to the equation 1 already addressed before, i.e. as

$$d = \frac{Δ t - {δ}_{p}}{2} \cdot c \qquad ( 1 )$$

where c is the speed of light and δp is the very small processing delay of the prover. In our implementation δp<1 ns resulting in a maximum error on about 15 cm.

The following section comprises two parts, the first (Section 5 and its sub-sections) concerning the security analysis of our distance bounding protocol of Section 4, and the second (Section 5A and its sub-sections) concerning the security analysis of our alternative distance bounding protocol of Section 4A.

### Section 5) Security Analysis

In this section we analyze the resistance of our protocol (of Section 4) to distance fraud and mafia fraud, as well as attacks against CRCS.

### Section 5.1) System And Attacker Model

We consider three nodes, the prover P, the verifier V and the attacker M. The goals for the three participants are as follows: the verifier wants to acquire an upper bound on the distance to the prover, i.e., the verifier wants to know that the prover is closer than a certain distance. The prover wants to prove to the verifier that he is within a certain distance. The goal of the attacker is to disrupt this process such that the verifier obtains an incorrect distance bound. The verifier holds an authentic public key of the prover. The attacker and the prover do not collude. The attacker corresponds to the standard Dolev-Yao attacker that controls the network and thus can eavesdrop on all the communication between the prover and the verifier, can arbitrary insert and remove messages to/from the communication channel. She is equally free to transmit nonsensical signals. The attacker knows the public parameters of the distance bounding protocol and the type of hardware used by the nodes and thus the processing times of the prover's and verifier's radios. She is only limited by the fact that it does not have access to the secrets that are held by the prover and the verifier and cannot break cryptographic primitives.

We consider two attacks: Distance fraud, where the prover tries to shorten the measured distance bound, and Mafia fraud where the attacker tries to shorten the bound (but does not collude with the prover). We show that our protocol resists to both attacks. There is a third type of attack in which the attacker colludes with the prover and has access to some, but not all, of the secret key material of the prover (e.g., only nonces and short-term secrets). This attack is often called the terrorist attack. We do not specifically address terrorist attacks, but it has been shown [4] that if needed, distance bounding protocols can be extended to generally protect against this attack.

### Section 5.2) Distance Fraud

Distance fraud is an attack performed by a malicious prover and consists of the prover trying to shorten the distance measured by the verifier. The verifier uses equation (1) (cf. Section 4) to calculate the distance to the prover. For the prover to “shorten” the distance to the verifier (without actually moving closer) he must manipulate the verifiers calculation and the only thing the prover can influence is Δt. For the prover to reduce the Δt measured by the verifier, thereby reducing the distance, he must make his replies arrive at the verifier sooner than they otherwise would, i.e., he must guess the correct reply (i.e., guess the challenge) and send it before the verifier expects. In our protocol, the reply which the prover must send back is the signal he receives on channel C₀. In order to do this, the prover must guess the content of the challenge signal since the content of the reply is checked by the verifier as a part of the verification process. The content of the challenge is Nᵥ and the probability of successfully guessing that is given by

$$\frac{1}{2 \vert {N}_{v} \vert} .$$

Attacks that rely on manipulation of the modulation scheme, e.g., “late commit” attacks described by Hancke and Kuhn [14] will not work on this protocol because the verifier uses auto-correlation to find the exact time-of-flight of the signal (as it is done in GPS receivers [20]) rather than using a peak or energy detector. This means that any manipulation done to, say, the first symbol of the response will not have any effect unless all subsequent symbols are also shifted forward. This would require the malicious prover to guess all the symbols in advance and can therefore only be done with negligible probability of

$$\frac{1}{2 \vert {N}_{v} \vert} .$$

The same argument applies to attacks where the prover tries to guess the first bit of the nonce [8]. Because the prover doesn't store and forward the nonce, but instead must reflect it directly, the prover would have to guess all the bits of the verifier's nonce to perform the attack. We can therefore conclude that the prover can commit distance fraud only with probability

$$\frac{1}{2 \vert {N}_{v} \vert} .$$

### Section 5.3) Mafia Fraud

Mafia fraud is an attack performed by an external attacker that physically resides closer to the verifier than the prover. The attack aims to make one of the parties (either the prover or the verifier or both) believe that the protocol was successfully executed when, in fact, the attacker shortened the distance measurement. The requirement that the attacker be closer to the verifier than the prover is only necessary because, if the attacker is further away the attack is trivially defeated by the protection against distance fraud attacks.

In order for an external attacker to shorten the distance measured by the verifier, the attacker must respond before the prover during the distance bounding phase. However, because of the checks performed by the verifier at the end of (or during) the distance bounding phase, it is not sufficient to just reply before the prover, the attacker must also make the value of his nonce match the commitment sent by the prover in the beginning of the protocol. Since the attacker can not find a nonce to match the commitment sent by the prover, e.g., find a collision for the hash function used to generate the commitment, the attacker is forced to replace the provers commitment with his own, thereby passing the commitment check. However, the attacker cannot fake the prover's signature in the final message so he cannot confirm the nonce.

The attacker can get the prover to reply before the prover receives Nᵥ, e.g., by sending his own early signal to the prover, however, this will result in the prover getting N′ᵥ≠Nᵥ which will be detected by the verifier in the final message. This assumes that any malicious change to the signal will result in a change in the demodulated nonce Nᵥ. If that cannot be guarantied, e.g., because of the sample rate at the prover or the modulation scheme used for communication, the prover can record the raw incoming signal and send it back to the verifier. The verifier can then, e.g., use autocorrelation to make sure the signal received by the prover is the same as what the verifier sent.

We can therefore conclude that an attacker can only commit mafia fraud if he can break, either the commitment scheme or the signature scheme used in the protocol.

However, because of the way the distance bounding radio extension is designed it is possible for an attacker to get the current bit of the provers nonce. As explained in Section 3.1, the prover's radio extension will shift any signal that arrives on the center channel to either channel C₁ or channel C₂ depending on the current bit of the provers nonce. An attacker can exploit this to get the current bit of the prover's nonce without the prover's knowledge. If the attacker sends a very weak signal, e.g., a DSSS [21] signal with a spreading code known only to the attacker, the attacker can determine what channel the response is sent back on, and therefore the current bit of the prover's nonce. Unless this is prevented, the attacker can use this information to perform a successful mafia fraud attack.

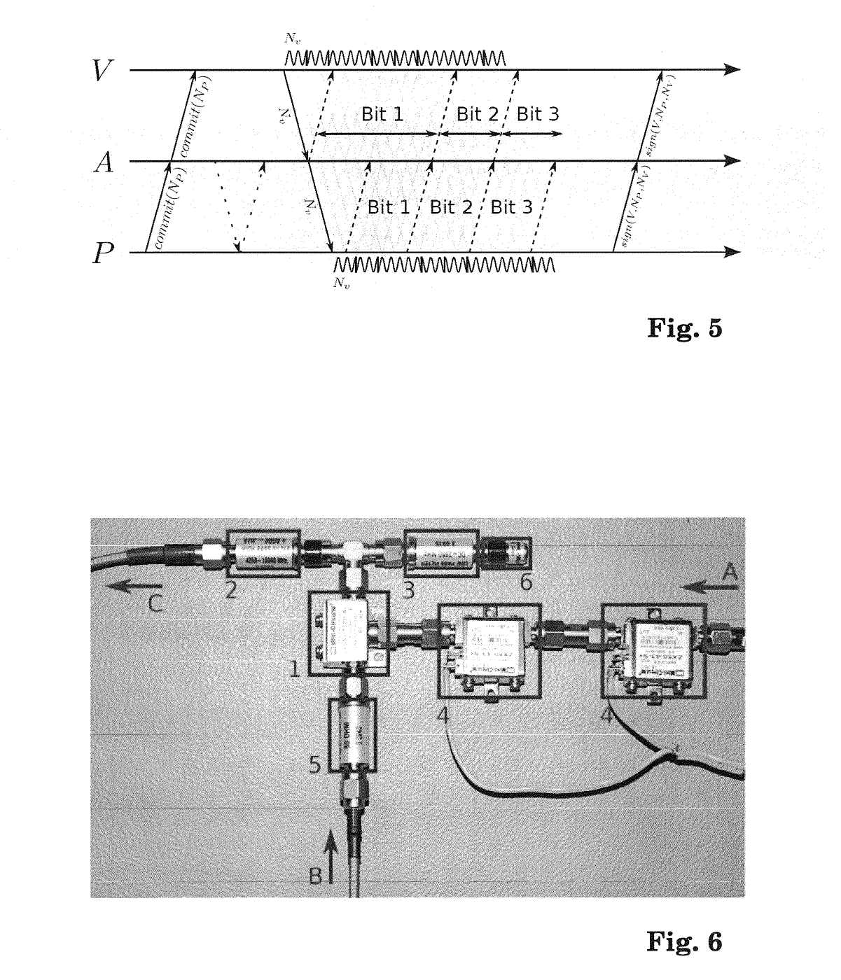

In order to prevent this attack the prover must make sure not to expose all the bits of his nonce before they are needed. There are two ways this can be ensured: Either the prover must only enable his distance bounding hardware once he is sure that the verifier has started his transmission or he must make sure that his reply bits (of Nₚ) are of exactly the same duration. Of course the time duration must also be known and later checked by the verifier. Our protocol uses the second method. FIG. 5 illustrates how this measure prevents the attack.

FIG. 5 illustrates a man in the middle attack. The figure shows the timing of the messages sent by the verifier V, the attacker M and the prover P. Even if the attacker is able to learn the value of the first bit on the prover's nonce, the attack will fail because the attacker is forced to make the first bit longer than the subsequent bits if he wants to reply early.

In the example of this figure the attacker obtains the value of the first bit of the provers nonce, and uses it to reply early to the verifier's challenge. However, because the prover doesn't expose the second bit of his nonce until after the duration of the first bit has expired, the attacker is forced to make the first bit ‘too long’, thus getting detected.

In order to perform this attack, the attacker would need to guess all the bits of Nₚ, which she can do only with the probability

$$\frac{1}{2 \vert {N}_{v} \vert} .$$

### Section 5A) Security Analysis of Alternative Protocol

In this section we analyze the resistance of our alternative protocol (of Section 4A) to distance fraud and mafia fraud, as well as attacks against CRCS.

### Section 5A.1) System And Attacker Model

We consider three nodes, the prover P, the verifier V and the attacker M. The goals for the three participants are as follows: the verifier wants to acquire an upper bound on the distance to the prover, i.e., the verifier wants to know that the prover is closer than a certain distance. The prover wants to prove to the verifier that he is within a certain distance. The goal of the attacker is to disrupt this process such that the verifier obtains an incorrect distance bound. The verifier is in possession of an authentic public key of the prover. We further assume that the attacker and the prover do not share secret key material. The attacker corresponds to the standard Dolev-Yao attacker that controls the network and thus can eavesdrop on all the communication between the prover and the verifier, and can arbitrary insert and remove messages to/from the communication channel. The attacker is free to transmit nonsensical signals and he knows the public parameters of the alternative distance bounding protocol. The attacker also knows the type of hardware being used by the nodes and thus the processing times of the prover's and verifier's radios. The attacker is only limited by the fact that he does not have access to the secrets that are held by the prover and the verifier and cannot break cryptographic primitives.

We consider two attacks: Distance fraud, where the prover tries to shorten the measured distance bound, and Mafia fraud where the attacker tries to shorten the bound (but does not collude with the prover). We show that our alternative protocol resists to both attacks. There is a third type of attack in which the attacker colludes with the prover and has access to some, but not all, of the secret key material of the prover (e.g., only nonces and short-term secrets). This attack is often called the terrorist attack. We do not specifically address terrorist attacks, but it has been shown [4] that if needed, distance bounding protocols can be extended to generally protect against this attack.

### Section 5A.2) Distance Fraud

Distance fraud is an attack performed by a malicious prover and consists of the prover trying to shorten the distance measured by the verifier.

The verifier uses equation (1) (cf. above, Section 4A) to calculate the distance to the prover. For the prover to “shorten” the distance to the verifier (without actually moving closer) he must manipulate the verifiers calculation and the only thing the prover can influence is Δt. For the prover to reduce the Δt measured by the verifier, thereby reducing the distance, he must make his replies arrive at the verifier sooner than they otherwise would, i.e., he must guess the correct reply (which means guessing the challenge) and send it before the verifier expects. In our alternative protocol, the reply which the prover must send back is the signal he receives on channel C₀. In order to reply earlier, the prover must guess the content of the challenge signal since the content of the reply is checked by the verifier as a part of the verification process. The content of the challenge is Nᵥ and the probability of successfully guessing that is given by

$$\frac{1}{2 \vert {N}_{v} \vert} .$$

Attacks that rely on manipulation of the modulation scheme, e.g., “late commit” attacks described by Hancke and Kuhn [14] will not work on this alternative protocol because the verifier uses auto-correlation to find the exact time-offlight of the signal (as it is done in GPS receivers [20]) rather than using a peak or energy detector. This means that any manipulation done to, say, the first symbol of the response will not have any effect unless all subsequent symbols are also shifted forward. This would require the malicious prover to guess all the symbols in advance and can therefore only be done with negligible probability of

$$\frac{1}{2 \vert {N}_{v} \vert} .$$

The same argument applies to attacks where the prover tries to guess the first bit of the nonce [8]. Because the prover doesn't store and forward the nonce, but instead must reflect it directly, the prover would have to guess all the bits of the verifier's nonce to perform the attack. We can therefore conclude that the prover can commit distance fraud only with probability

$$\frac{1}{2 \vert {N}_{v} \vert} .$$

### Section 5A.3) Mafia Fraud

Mafia fraud is an attack performed by an external attacker that physically resides closer to the verifier than the prover. The attack aims to make one of the parties (either the prover or the verifier or both) believe that the (alternative) protocol was successfully executed when, in fact, the attacker shortened the distance measurement. The requirement that the attacker be closer to the verifier than the prover is only necessary because, if the attacker is further away the attack is trivially defeated by the protection against distance fraud attacks.

In order for an external attacker to shorten the distance measured by the verifier, the attacker must respond before the prover during the distance bounding phase. However, because of the checks performed by the verifier at the end of (or during) the distance bounding phase, it is not sufficient to just reply before the prover, the attacker must also make the value of his nonce match the commitment sent by the prover in the beginning of the alternative protocol. Since the attacker cannot find a nonce to match the commitment sent by the prover, e.g., find a collision for the hash function used to generate the commitment, the attacker is forced to replace the prover's commitment with his own, thereby passing the commitment check. However, the attacker cannot fake the prover's signature in the first (and last) message so he cannot assume the prover's identity.

The attacker can get the prover to reply before the prover receives Nᵥ, e.g., by sending his own early signal to the prover, however, this will result in the prover getting N′ᵥ≠Nᵥ which will be detected by the verifier in the final message. This assumes that any malicious change to the signal will result in a change in the demodulated nonce Nᵥ. If that cannot be guaranteed, e.g., because of the sample rate at the prover or the modulation scheme used for communication, the prover can record the raw incoming signal and send it back to the verifier. The verifier can then, e.g., use autocorrelation to make sure the signal received by the prover is the same as what the verifier sent.

We can therefore conclude that an attacker can only commit mafia fraud if he can break, either the commitment scheme or the signature scheme used in the alternative protocol.

Because of the way the distance bounding radio extension is designed it is possible for an attacker to get the current bit of the provers nonce. As explained in Section 3, the prover's radio extension will shift any signal that arrives on the center channel to either channel C₁ or channel C₂ depending on the current bit of the provers nonce. An attacker can exploit this to get the first bit of the prover's nonce without the prover's knowledge. If the attacker sends a very weak signal, e.g., a DSSS [21] signal with a spreading code known only to the attacker, the attacker can determine what channel the response is sent back on, and therefore the first bit of the prover's nonce. Unless this is prevented, the attacker can use this information to perform a successful mafia fraud attack.

In order to prevent this attack the prover must make sure not to expose all the bits of his nonce before they are needed. There are two ways this can be ensured: Either the prover must only enable his distance bounding hardware once he is sure that the verifier has started his transmission or he must make sure that his reply bits (of Nₚ) are of exactly the same duration.

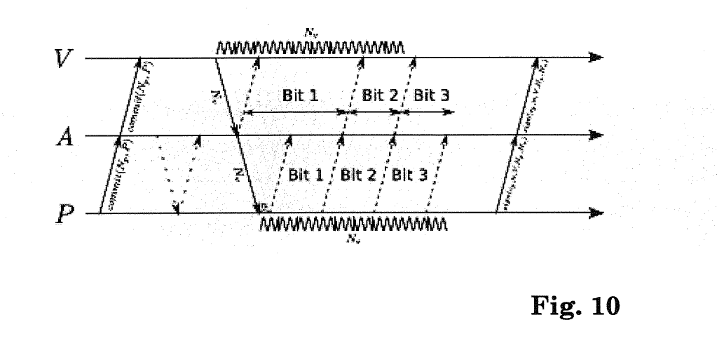

Of course the time duration must also be known and later checked by the verifier. Our alternative protocol uses the second method. FIG. 10 illustrates how this measure prevents the attack. In the example of this figure the attacker obtains the value of the first bit of the prover's nonce, and uses it to reply early to the verifier's challenge. However, because the prover doesn't expose the second bit of his nonce until after the duration of the first bit has expired, the attacker is forced to make the first bit ‘too long’, thus getting detected. The value of n prevents the attacker from reflecting the challenge and then later provide the correct bits of Np as they are reveled by the prover.

In order to perform this attack, the attacker would need to guess all the bits of Nₚ, which he can do only with the probability

$$\frac{1}{2 \vert {N}_{v} \vert} .$$

### Section 6) Implementation and Measurements

In this section, we describe our implementation of the prover and the related measurement results. What we present works with the protocol of Section 4 as well as with the alternative protocol of Section 4A. Our prototype can be seen on FIG. 6. FIG. 6 shows a picture showing a prototype implementation of a prover consisting of a mixer 1, a high-pass filter 2, a low-pass filter 3, four amplifiers 4 (only two visible), a 1 dB attenuator 5 and a terminating resistor 6. The signal from the receiving antenna A is mixed with the local oscillator B and sent to the transmitting antenna C. The yellow wires are power (+5V). This prototype is an implementation of the scheme described in FIG. 2.

The central part of the prototype is the mixer 1 which is responsible for shifting the received challenge up and down in frequency. The signal from the receiving antenna comes in from the right A and passes through four amplifiers 4 to bring it up to a power level where it can be mixed by our mixer. The local 500 MHz sine wave used for the mixing, comes in from the bottom of FIG. 6 (ref. B) and is passed through a 1 dB attenuator 5 to bring it to the same level as the radio signal before mixing. The output of the mixer is split in two and each is passed through either a high-pass filter 2 or a low-pass filter 3 to eliminate the unwanted channel. In this prototype we did not implement the switching mechanism. Instead channel C₂ is fed directly to the transmission antenna C. In order for the signal to split properly, both sides must have a similar load. For this reason we added a 50Ω resistor 6 to terminate the unused channel C₁. The implementation of the switching mechanism can be done using a simple transistor based switch. We note, that the switch can only marginally increase the processing delay since, once set to a particular channel, the switch essentially acts as a piece of very short wire connecting the setup to the antenna. This prototype is an implementation of the scheme described in FIG. 2.

### Section 6.1) Delay at the Prover

We first wanted to see if our prototype implementation could receive a signal, shift it to another channel and transmit it back to the verifier in ≦1 ns.

In order to test this, we first transmit the challenge and response signals through cables so as to better be able to control signal strength and reduce noise (later we show that the same setup works using wireless communication as well). The challenge signal sent on channel C₀ is a 3.5 GHz sine, modulated by a 1 Hz pulse so it is easy to see and capture the start of a new “bit”. Our response signal is sent back on channel C₂ at 4.0 GHz (i.e., f_{c}=3.5 GHz and f_{Δ}=0.5 GHz). We generated the 3.5 GHz challenge using a function generator. The generated signal is split by a power splitter and one end is fed, via a 1 meter cable, into our prototype. The other end was connected to a 40Gs/s oscilloscope, via another 1 meter cable, to provide the ground truth signal to which we compare the delay of our prototype. Because both cables have the same length, the 3.5 GHz signal (the challenge) will arrive at the same time at the oscilloscope and at the reception point of our prototype. The output (the response) from the prototype is plugged directly into another input of the same oscilloscope (keeping the signal path as short as we could make it using this setup).

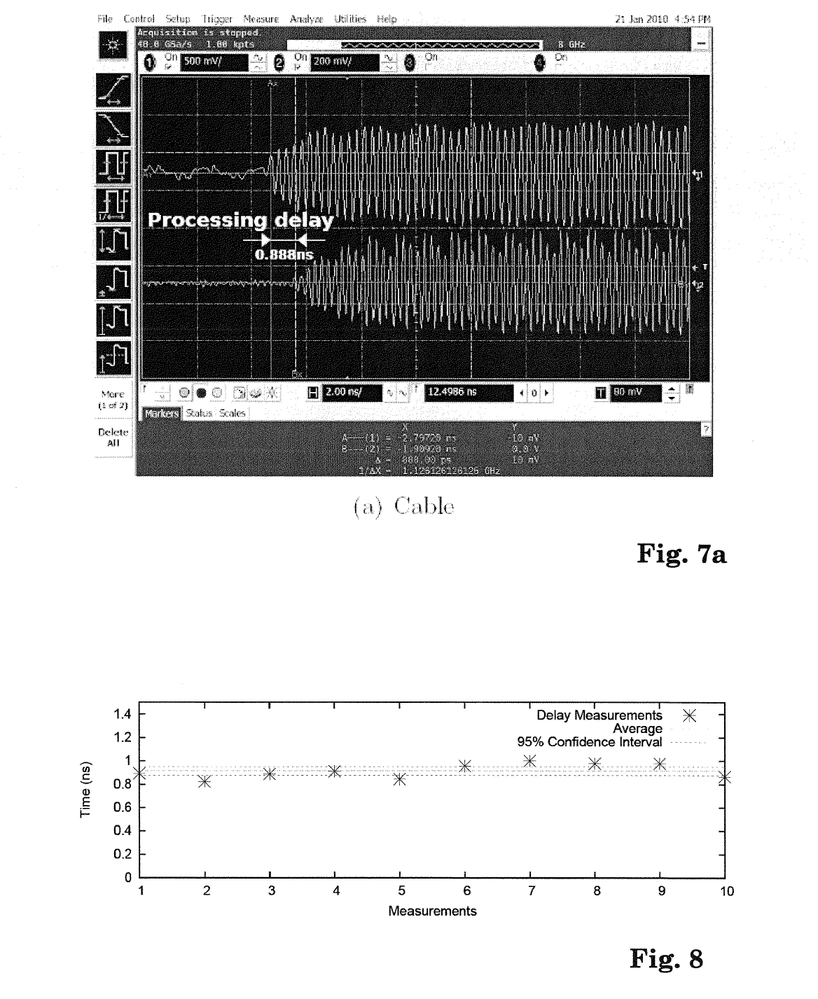

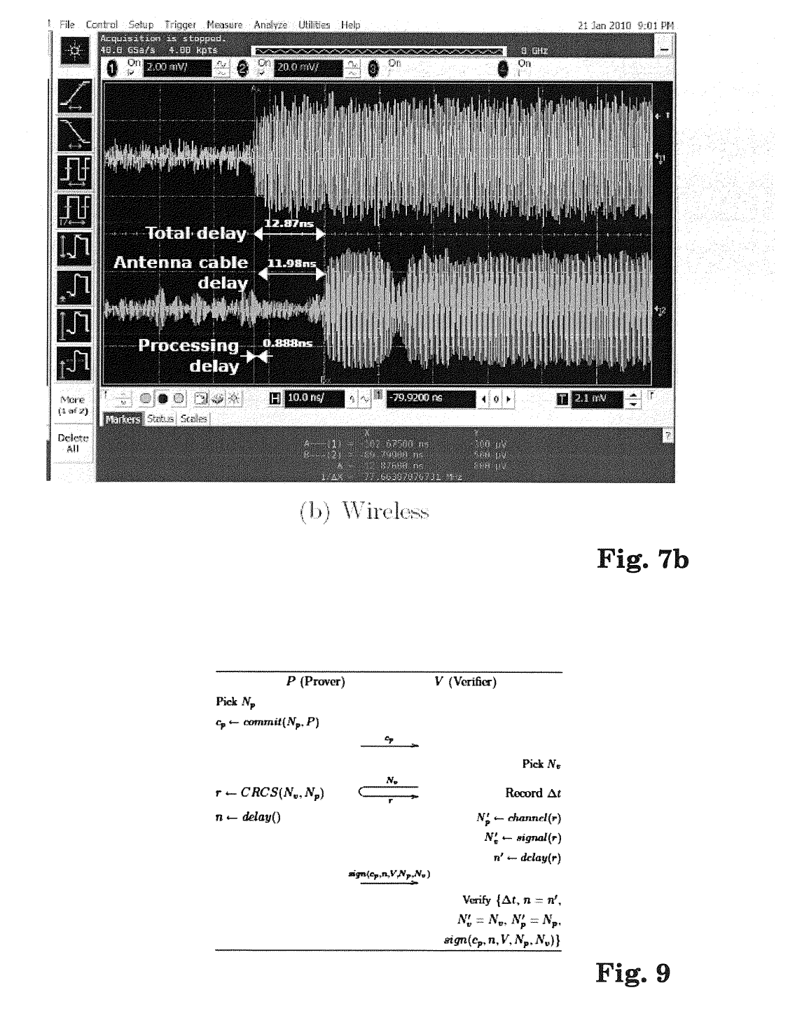

FIG. 7 (FIG. 7a for wirebound transmission and FIG. 7b for wireless transmission) illustrates the delay of the prover's distance bounding radio extension. The top signal is measured at the reception antenna of the provers radio and is transmitted on channel C₀ at 3.5 GHz. The bottom signal is measured at the transmission antenna and is being transmitted at the C₂ channel at 4.0 GHz. The delay between them, and thus the prover's processing time is 0.888 ns.

FIG. 7a shows the two signals. The top (yellow) signal is coming directly from the function generator. It is an exact copy of the signal that arrives at the input of our prototype (this signal arrives at the oscilloscope and at the prototype input at the same time). The bottom (green) signal is what comes out of our prototype implementation. It is a 4.0 GHz signal, i.e., the original signal shifted up by 500 MHz. We see that the difference in arrival times between these two signals (i.e., the processing time of the prover) is 0.888 ns. As described in Section 2 the delay at the prover determines the theoretical advantage a powerful attacker might get. If we translate 0.888 ns into distance, the maximum theoretical distance by which an attacker will be able to shorten its distance is about 12 cm.

We repeated this measurement 10 times, using the same setup. FIG. 8 shows a diagram showing processing time at a prover. The ten different delay measurements were done using our measurement setup described in Section 6.1. The figure shows that the variation in processing time is small (σ=61.22 ps) and that the average processing delay is μ=912.92 ps. I.e., less than 1 ns.

FIG. 8 shows all 10 measured processing times along with their average value and a 95% confidence interval. We see from the figure that the processing time of the prover is stable between 0.8 ns and 1 ns.

Note that if the same setup would have been implemented in an integrated circuit, the signal path would be a lot shorter and consequently the processing time would have been smaller. We therefore do not claim that our prototype is the best that can be achieved, rather it shows the processing time that can be achieved using standard SMA components.

### Section 6.2) Wireless Implementation

Since distance bounding protocols are primarily useful in wireless environments, in this section we show that our prototype equally enables distance bounding using wireless communication (instead of wires). The basic construction of the prover is the same as in the wired setup, except that the prototype input and output are connected to antennas. The function generator that generates the verifiers signal and the oscilloscope used to measure the round trip time are likewise connected to antennas.

The result of the wireless implementation can be seen in FIG. 7b. Unfortunately we had to use SMA cables of about 1 m to connect the antennas because of the way the antennas are mounted. In addition there was about 0.1 m between the transmission antenna and the receiving antenna. This results in a delay introduced by the cables and the space between the antennas referred to on FIG. 7b as “antenna cable delay”. The output of the prototype was passed through a high-pass filter and the input passed through a low-pass filter to prevent the transmitting antenna from feeding back into the receiving antenna. The oscilloscope used to measure the difference in arrival time also had filters to separate the ground truth signal, i.e., the signal coming directly from the function generator from the one being transmitted by the prototype. The filters allowed for a full duplex wireless channel to be created between our wireless prototype and the function generator and oscilloscope.

It should be noted that the channel switching mechanism of our prototype is ideal for a wireless implementation. Any wireless distance bounding protocol needs more than one channel (i.e., full duplex) in order to reply as fast as possible. Encoding the prover's reply in the choice of channel means that the solution is strait forward to apply without causing interference between the prover and verifier.

### Section 7) Conclusion

We demonstrated that radio distance bounding protocols can be implemented to match the strict processing that these protocols require (i.e., that the prover receives, processes and transmits signals in 1 ns). This can be achieved using a specially implemented concatenation as the prover's processing function. Through this we showed that the use of processing functions which require that the prover demodulates (interprets) the verifier's challenge before responding to it, is not desirable or necessary for distance bounding. Finally, we showed that other processing functions such as XOR and the comparison function, that were used in a number of proposed distance bounding protocols, are not best suited for the implementation of radio distance bounding.

### REFERENCES

[1] Thomas Beth and Yvo Desmedt. Identification tokens—or: Solving the chess grandmaster problem. In CRYPTO '90: Proceedings of the 10th Annual International Cryptology Conference on Advances in Cryptology, pages 169-177, London, UK, 1991. Springer-Verlag.
[2] Colin Boyd and Anish Mathuria. Protocols for authentication and key establishment. Springer, 1998.
[3] Stefan Brands and David Chaum. Distancebounding protocols. In EUROCRYPT '93, pages 344-359, Secaucus, N.J., USA, 1994. Springer-Verlag New York, Inc.
[4] Laurent Bussard and Walid Bagga. Distancebounding proof of knowledge protocols to avoid terrorist fraud attacks. Technical report, Institut Eurecom, France, 05 2004.
[5] Srdjan \check{C}apkun and Jean-Pierre Hubaux. Secure positioning of wireless devices with application to sensor networks. In IEEE INFOCOM, 2005.
[6] Nishanth Chandran, Vipul Goyal, Ryan Moriarty, and Rafail Ostrovsky. Position based cryptography. In CRYPTO '09: Proceedings of the 29th Annual International Cryptology Conference on Advances in Cryptology, pages 391-407, Berlin, Heidelberg, 2009. Springer-Verlag.
[7] Jerry T. Chiang, Jason J. Haas, and Yih-Chun Hu. Secure and precise location verification using distance bounding and simultaneous multilateration. In ACM WiSec '09, pages 181-192, New York, N.Y., USA, 2009. ACM.
[8] Jolyon Clulow, Gerhard P. Hancke, Markus G. Kuhn, and Tyler Moore. So near and yet so far: Distance-bounding attacks in wireless networks. In Proceedings of the European Workshop on Security and Privacy in Ad-hoc and Sensor Networks (ESAS), 2006.
[9] Yvo Desmedt. Position statement in rfid s&p panel: From relative security to perceived secure. In Financial Cryptography, pages 53-56, 2007.
[10] Saar Drimer and Steven J. Murdoch. Keep your enemies close: Distance bounding against smartcard relay attacks. In Proceedings of the USENIX Security Symposium 2007, 2007.
[11] Manuel Flury, Marcin Poturalski, Panos Papadimitratos, Jean-Pierre Hubaux, and Jean-Yves Le Boudec. Effectiveness of Distance-Decreasing Attacks Against Impulse Radio Ranging. In 3rd ACM Conference on Wireless Network Security (WiSec), 2010.
[12] S. Gezici, Zhi Tian, G. B. Giannakis, H. Kobayashi, A. F. Molisch, H. V. Poor, and Z. Sahinoglu. Localization via ultra-wideband radios: a look at positioning aspects for future sensor networks. Signal Processing Magazine, IEEE, 22(4):70-84, July 2005.
[13] Gerhard P. Hancke and Markus G. Kuhn. An rfid distance bounding protocol. In SecureComm '05: Proceedings of the First International Conference on Security and Privacy for Emerging Areas in Communications Networks, pages 67-73, Washington, D.C., USA, 2005. IEEE Computer Society.
[14] Gerhard P. Hancke and Markus G. Kuhn. Attacks on time-of-flight distance bounding channels. In WiSec '08: Proceedings of the first ACM conference on Wireless net work security, pages 194-202, New York, N.Y., USA, 2008. ACM.
[15] Y.-C. Hu, A. Perrig, and D. B. Johnson. Packet Leashes: A Defense against Wormhole Attacks in Wireless Networks. In Proceedings of the IEEE Conference on Computer Communications (InfoCom), San Francisco, USA, April 2003.
[16] Yih-Chun Hu, Adrian Perrig, and David B. Johnson. Ariadne: a secure on-demand routing protocol for ad hoc-networks. Wirel. Netw., 11(1-2):21-38, 2005.
[17] J.-Y. Lee and R.A. Scholtz. Ranging in a Dense Multipath Environment Using an UWB Radio Link. IEEE Journal on Selected Areas in Communications, 20(9), December 2002.
[18] Catherine Meadows, Paul Syverson, and LiWu Chang. Towards more efficient distance bounding protocols for use in sensor networks. Securecomm, pages 1-5, Aug. 28 2006-Sep. 1, 2006.
[19] Jorge Munilla, Andres Ortiz, and Alberto Peinado. Distance bounding protocols with void-challenges for RFID. Printed handout at the Workshop on RFID Security—RFIDSec 06, July 2006.
[20] National Space-Based Positioning, Navigation, and Timing Coordination Office. Global positioning system. http://www.gps.gov/.
[21] Maxim Integrated Products. An introduction to direct sequence spread spectrum communications. http://www.maxim-ic.com/, 2003.
[22] Kasper Bonne Rasmussen, Claude Castelluccia, Thomas S. Heydt-Benjamin, and Srdjan \check{C}apkun. Proximity-based access control for implantable medical devices. In CCS '09: Proceedings of the 16th ACM conference on Computer and communications security. ACM, 2009.
[23] Kasper Bonne Rasmussen and Srdjan \check{C}apkun. Location privacy of distance bounding protocols. In CCS '08: Proceedings of the 15th ACM conference on Computer and communications security, pages 149-160, New York, N.Y., USA, 2008. ACM.
[24] Qingchun Ren and Qilian Liang. Throughput and energy-efficiency-aware protocol for ultrawideband communication in wireless sensor networks: A cross-layer approach. IEEE Transactions on Mobile Computing, 7:805-816, 2007.
[25] Naveen Sastry, Umesh Shankar, and David Wagner. Secure verification of location claims. InWiSe '03: Proceedings of the 2nd ACM workshop on Wireless security, New York, N.Y., USA, 2003. ACM.
[26] Patrick Schaller, Benedikt Schmidt, David Basin, and Srdjan Capkun. Modeling and verifying physical properties of security protocols for wireless networks. In CSF '09: Proceedings of the 2009 22nd IEEE Computer Security Foundations Symposium, pages 109-123, Washington, D.C., USA, 2009. IEEE Computer Society.
[27] S. Sedighpour, S. Capkun, S. Ganeriwal, and M. Srivastava. Implementation of attacks on ultrasonic ranging systems, nov 2005.
[28] D. Singelee and B. Preneel. Location verification using secure distance bounding protocols. In Mobile Adhoc and Sensor Systems Conference, 2005. IEEE International Conference on, November 2005.
[29] Nils Ole Tippenhauer and Srdjan \check{C}apkun. Id-based secure distance bounding and localization. In In Proceedings of ESORICS (European Symposium on Research in Computer Security), 2009.
[30] S. \check{C}apkun, L. Buttyán, and J.-P. Hubaux. SECTOR: Secure Tracking of Node Encounters in Multi-hop Wireless Networks. In Proceedings of the ACM Workshop on Security of Ad Hoc and Sensor Networks (SASN), Washington, USA, October 2003.
[31] Srdjan \check{C}apkun, Levente Buttyán, and Jean-Pierre Hubaux. Sector: secure tracking of node encounters in multi-hop wireless networks. In ACM SASN '03, pages 21-32, New York, N.Y., USA, 2003. ACM.
[32] Srdjan \check{C}apkun and Mario \check{C}agalj. Integrity regions: authentication through presence in wireless networks. In WiSe '06: Proceedings of the 5th ACM workshop on Wireless security, pages 1-10. ACM, 2006.

1. A method for communicating between a first device and a second device, that is preferably a reader for reading data from the first device and optionally destined for controlling the first device, the method comprising the steps of:
the first and second device communicating by exchanging messages that are based on signals that are transmitted through a plurality of communication channels;
the first device sending a challenge message to the second device over one communication channel;
the second device sending, upon reception of the challenge message, a response message to the first device through at least two communication channels that have essentially identical signal propagation velocities;
the first device measuring the time elapsed between the sending of the challenge message to the reception of the response message; and
the first device computing its distance to the second device based on this time, knowledge about travelling speed of the challenge and the response message and the processing delay that the second device adds to generate and send the response message;
wherein the second device:
encodes its response message by choosing a subset of the at least two communication channels;
generates said response message purely through an analogue signal processing means.

2. The method of claim 1, comprising the further step of:
the first and second device by exchanging the messages, establish a shared secret key.

3. The method of claim 1, comprising the further steps of:
defining a fixed nonce length for the first device and a fixed nonce length for the second device;
given a shared secret key, the first and second device each picking a random nonce at the defined lengths;
the first device encoding its chosen nonce into the challenge message;
calculating a constant time period as a fraction of the temporal length of the challenge message and thus a number of such constant time periods that fit into the temporal length of the challenge message;
the second device encoding its chosen nonce into the resulting number of calculated constant time periods, by choosing a subset of communication channels of the at least two communication channels for each of the defined constant time periods, to essentially reflect the portion of the challenge message that the second device receives during that constant time period, until the entire challenge message is piecewise reflected, this way, and the entire chosen nonce of the second device is encoded through this continuous choice of communication channels;
the first device decoding the chosen nonce of the second device by listening on the plurality of communication channels and using knowledge of the constant time period and knowledge of the way the second device encodes its nonce into the choice of the subset of communication channels.

4. The method of claim 3, comprising the further steps of:
the second device signing the nonce of the first device and the nonce of the second device with a shared secret key and thus establishing an additional message;
the second device sending that additional message to the first device;
the first device verifying the additional message by knowledge of his chosen nonce, the nonce chosen by the second device previously decoded by listening on the plurality of communication channels and by knowledge of the shared secret key.

5. The method of claim 1, wherein all of the communication channels are based on RF communication.

6. The method of claim 1, wherein the step of controlling access of the second device to the first device, in addition to the distance, takes into account credential information.

7. The method of claim 3, wherein the credential information is a preshared key known to the first and the second device, or the credential information is a cryptographic certificate, and the credential information is stored on a storage device that is separable from the second device.

8. The method of claim 1, wherein the first device comprises two or more levels of access, and the method comprises the further step of:
the first device controlling access to the different levels of access depending on the value of the computed distance.

9. A distance bounding system comprising:
a first device,
and a second device,
said first device being configured to communicate with said second device, and
said second device being configured to communicate with said first device, said first device comprising
a first transceiver for sending and receiving messages through a first communication channel;
a receiver for listening to a plurality of communications channels;
the first device being configured to
exchange messages through the first communication channel and/or through the plurality of communication channels;
compute the distance to the second device based on communication signal delays caused by the difference in signal propagation velocities; and
depending on the computed distance, to accept data from the second device and optionally also to control access to the device;
said second device comprising
a second transceiver for sending and receiving messages through said first communication channel;
at least one other transceiver or sending messages through a second or further communication channels;
an analogue processing means, capable of reflecting received messages from the first transceiver and selecting the communication channel through which the received message is reflected;
wherein said second or further communication channels are comprised in said plurality of communication channels.

10. A distance bounding system according to claim 9, where the analogue processing means and/or one of the transceivers of the second device comprise:
an electronic oscillator, oscillating with a frequency Δf;
a high pass filter with a cut off frequency below f_{c}+Δf and above f_{c}−Δf, with f_{c} being the center frequency of the first communication channel;
a low pass filter with a cut off frequency above f_{c}−Δf and below f_{c}+Δf;
an analogue selector with a first input signal having a center frequency of f_{c}+Δf, a second input signal having a center frequency of f_{c}−Δf and a third, essentially binary input, selecting one of the two first input signals as its output signal.

11. A first device, configured to communicate with a further device, comprising
a transceiver for sending and receiving messages through a first communication channel;
a receiver for listening to a plurality of communications channels;
the device being configured to:
exchange messages through the first communication channel and/or through the second plurality of communication channels;
to compute the distance to the further device based on communication signal delays caused by the difference in signal propagation velocities; and
depending on the computed distance, to accept data from the further device and also to control access to the device.

12. A second device, configured to communicate with a further device, comprising
a first transceiver for sending and receiving messages through a first communication channel;
at least one other transceiver for sending messages through a second or further communication channels;
an analogue processing means, capable of reflecting received messages from the first transceiver and selecting the communication channel through which the received message is reflected.

13. A second device according to claim 12, where the analogue processing means and/or one of the transceivers comprise:
an electronic oscillator, oscillating with a frequency Δf;
a high pass filter with a cut off frequency below f_{c}+Δf and above f_{c}−Δf, with f_{c} being the center frequency of the first communication channel;
a low pass filter with a cut off frequency above f_{c}−Δf and below f_{c}+Δf;
an analogue selector with a first input signal having a center frequency of f_{c}+Δf, a second input signal having a center frequency of f_{c}−Δf and a third, essentially binary input, selecting one of the two first input signals as its output signal.
